(19) United States
(12) Patent Application Publication
(10) Pub. No.: US 2015/0085359 A1
(43) Pub. Date: Mar. 26, 2015

(54) MICROSCOPE SUPER-RESOLUTION ILLUMINATION SOURCE

(71) Applicants: Luis Molina, Doral, FL (US); L. J, Technology, LLC, Hialeah, FL (US)

(72) Inventor: Luis Molina, Doral, FL (US)

(73) Assignee: L.J. TECHNOLOGY, LLC, Hialeah, FL (US)

(21) Appl. No.: 14/033,429

(22) Filed: Sep. 20, 2013

(51) Int. Cl. G02B 21/06

(52) U.S. Cl. CPC G02B 21/06
USPC 359/385

(57) ABSTRACT

An alternative illumination source for traditional optical microscopes is provided. This super-resolution illumination source permits to use a traditional optical microscope for the direct observation of objects smaller than 100 nanometers such as subcellular structures in microorganisms, carbon nanotubes and other nanosize objects, and even nanostructures fabricated on top of a silicon wafer. This invention relies on the integration of two functional elements: a microscope, and the super-resolution illumination source. The super-resolution illumination source is formed by an array of light emitting diodes (LEDs) uniformly distributed in a hemisphere. The object under observation is illuminated by the light emitted in all directions by the array of LEDs. Real, wide-field images of the sample with nano-resolution are direct and analogically formed by the microscope's lenses, without the need of sample tagging, intensive computation or scanning. Depending on the wavelength emission of the LEDs, nano-resolution can be obtained with ultraviolet, infrared, and visible illumination.

### BACKGROUND OF THE INVENTION

1. Field of the Invention

The disclosure relates generally to illumination sources and more specifically, to alternative illumination sources for traditional optical microscopes.

2. Description of the Related Art

Traditional microscopy is diffraction-limited to spatial periods (p) larger than ˜λ/NA or separation between two points (Δx) larger than ˜0.5 to 0.8 times λ/NA where λ is the free space wavelength of the illuminating radiation and NA is the numerical aperture of the microscope's objective lens (see for instance the following publications: Feynman R P, Leighton R B, Sands M, The Feynman Lectures on Physics, Addison-Wesley, Mass., Sixth Edition, Vol. I, pages 30-(1-5), 1977; Hecht E, Optic, Addison Wesley, Mass., Third Edition, pages 439-472, 1998; Born M, and Wolf E, Principles of Optics, Pergamon Press, Oxford, Fifth Edition, pages 418-424, 1975; Durant S, Liu Z, Steele J M, Zhang X, Theory of the transmission properties of an optical far-field superlens for imaging beyond the diffraction limit, J. Opt. Soc. Am. B, vol. 23, pages 2383-2392, 2006). For instance, a typical optical microscope illuminated with a monochromatic source of illumination with λ=568 nm and NA=1.49, has a minimum resolvable values of p˜380 nm and Δx˜200 nm.

Optical images with sub-wavelength resolution have been achieved with several scanning techniques and non-scanning near-field approaches. Optical wide-field images with sub-wavelength resolution have also been obtained in the far-field by numerical reconstruction of the Moiré patterns formed directly in the image plane of the microscope or by using multilayer hyper-lenses. Surface waves of different nature have also being used to obtain far-field optical sub-wavelength resolution. However, all the above-mentioned optical imaging techniques require either special sample fabrication or intensive numerical image post-processing.

There is, therefore, a need for a non-scanning, far-field, optical imaging system with sub-wavelength resolution and method thereof that does not require special sample fabrication or intensive numerical image post-processing.

### BRIEF SUMMARY OF THE INVENTION

A portable microscope super-resolution illumination (SRI) apparatus includes a two-dimensional (2D) array of individual sources of radiation distributed in the internal surface of a solid body. The microscope SRI apparatus further includes a power supply having an electronic circuit adapted to power and to control the array of individual sources of radiation. In one aspect of this embodiment, the individual sources of the microscope SRI apparatus emit radiation in the visible frequency range of the spectrum. In another aspect of this embodiment, the individual sources of the microscope SRI apparatus emit radiation in the infrared frequency range of the spectrum. In yet another aspect of this embodiment, the body housing has a shape selected from the group consisting of a cylinder, a paraboloid, an ellipsoid and a flat screen.

In another embodiment, a super-resolution microscope system can be provided. The super-resolution illumination (SRI) microscope system includes a conventional optical microscope and a portable microscope super-resolution illumination (SRI) apparatus adapted for use with the conventional optical microscope to provide direct observation of objects smaller than a wavelength of radiation used for illumination. The microscope SRI apparatus includes a two-dimensional (2D) array of individual sources of radiation distributed in the internal surface of a body housing, and a power supply with an electronic circuit designed to power and control the array of individual sources of radiation. In one aspect of this embodiment, the individual sources of the microscope SRI apparatus emit radiation in the visible frequency range of the spectrum. In another aspect of this embodiment, the individual sources of the microscope SRI apparatus emit radiation in the infrared frequency range of the spectrum. In yet another aspect of this embodiment, the body housing has a shape selected from the group consisting of a cylinder, a paraboloid, an ellipsoid and a flat screen.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1A is a side view of an exemplary illustration of a hemisphere-shaped super-resolution illumination (SRI) source, in accordance with one embodiment of the present invention;

FIG. 1B is a is a bottom view of an exemplary illustration of a hemisphere-shaped super-resolution illumination (SRI) source, in accordance with one embodiment of the present invention;

FIG. 2 is a block diagram illustrating the various components of a SRI microscope system, in accordance with one embodiment of the present invention;

FIG. 3A is a side view of an exemplary illustration of a SRI source, according to an alternative embodiment of the present invention;

FIG. 3B is a is a bottom view of an exemplary illustration of a SRI source, according to an alternative embodiment of the present invention;

FIG. 4 is an exemplary illustration of a cylindrical SRI source, according to yet another embodiment of the present invention;

FIG. 5 is an exemplary illustration of a cylindrical SRI source, according to an alternative preferred embodiment of the present invention;

FIGS. 6A and 6B illustrate an instance of sub-wavelength resolution images obtained with a preferred embodiment of this invention in which FIG. 6A illustrates a real plane image and FIG. 6B illustrates a Fourier plane image obtained with a SRI-microscope arrangement corresponding to a sample with a period of 260 nm;

FIGS. 6C and 6D illustrate an instance of sub-wavelength resolution images obtained with a preferred embodiment of this invention in which FIG. 6C illustrates a real plane image and FIG. 6D illustrates a Fourier plane image obtained with a SRI-microscope arrangement corresponding to a sample with a period of 220 nm;

FIGS. 7A and 7B illustrate two instances of sub-wavelength resolution images obtained with a preferred embodiment of this invention, in which images obtained with a SRI-microscope arrangement correspond to a sample with C nanotubes, which have a diameter of 40-60 nm and a sample of human blood placed on top of a glass slide;

FIG. 8 illustrates an external control circuit that powers and controls the plurality of radiation sources of the SRI source of the SRI-microscope arrangement;

FIG. 9A is a side view of an exemplary illustration of a SRI source, according to an alternative embodiment of the present invention; and

FIG. 9B is a bottom view of an exemplary illustration of a SRI source, according to an alternative embodiment of the present invention.

### DETAILED DESCRIPTION OF THE INVENTION

Embodiments of the present invention provide an alternative super-resolution illumination apparatus for use with conventional optical microscopes. In accordance with an embodiment of the present invention, a portable microscope super-resolution illumination (SRI) apparatus includes a two-dimensional (2D) array of individual sources of radiation distributed on the internal surface of a housing body. The microscope SRI apparatus further includes a power supply having an electronic circuit adapted to power and to control the array of individual sources of radiation. In one aspect of this embodiment, the individual sources of the microscope SRI apparatus emit radiation in the visible frequency range of the spectrum. In another aspect of this embodiment, the individual sources of the microscope SRI apparatus emit radiation in the infrared frequency range of the spectrum. In another embodiment, a super-resolution microscope system can be provided. The super-resolution illumination (SRI) microscope system includes a conventional optical microscope and a portable microscope super-resolution illumination (SRI) apparatus adapted for use with the conventional optical microscope to provide direct observation of objects smaller than a wavelength of radiation used for illumination. The microscope SRI apparatus includes a two-dimensional (2D) array of individual sources of radiation distributed in the internal surface of a body housing, and a power supply with an electronic circuit designed to power and control the array of individual sources of radiation.

Traditional microscopy is diffraction-limited to spatial periods (p) larger than ˜λ/NA or separation between two points (Δx) larger than ˜0.5 to 0.8 times λ/NA where λ is the free space wavelength of the illuminating radiation and NA is the numerical aperture of the microscope's objective lens. For instance, a typical optical microscope illuminated with a monochromatic source of illumination with λ=568 nm and NA=1.49, has a minimum resolvable values of p˜380 nm and Δx˜200 nm. However, by using the present invention, a simple substitution of the traditional source of illumination of the microscope by a visible-light super-resolution illumination source, super resolution with minimum values of p˜200 nm and Δx<100 nm can be obtained. These values can be reduced using an ultraviolet SRI source. In another embodiment, the invention also results in an infrared wide-field nanoscope with λ=1.5 μm having similar resolution limit than that demonstrated using visible light, which is much smaller than the resolution limit of any existing infrared microscope.

As in conventional optical microscopes, the object under observation is placed over a glass slide. In a preferred and demonstrated embodiment of this invention, a visible-light SRI source is fabricated using 560 light emitting diodes (LED) distributed uniformly on the inner surface of a hemisphere having a diameter of 10 cm. The object under observation is illuminated in all directions for the light emitted by the LEDs, which includes light with very large incidence angles and which results in the demonstrated sub-wavelength resolution of the SRI-microscope system. In conventional microscopy, imaging occurs in the SRI-microscope system after collection by the microscope objective lens of the light directly diffracted by the object under observation. An alternative embodiment of this invention uses an ultraviolet or an infrared (wavelength ˜1.5 μm) SRI source. Notably, the use of an infrared SRI source can produce infrared images with unprecedented sub-wavelength resolution and therefore obtain features fabricated on top of a silicon wafer.

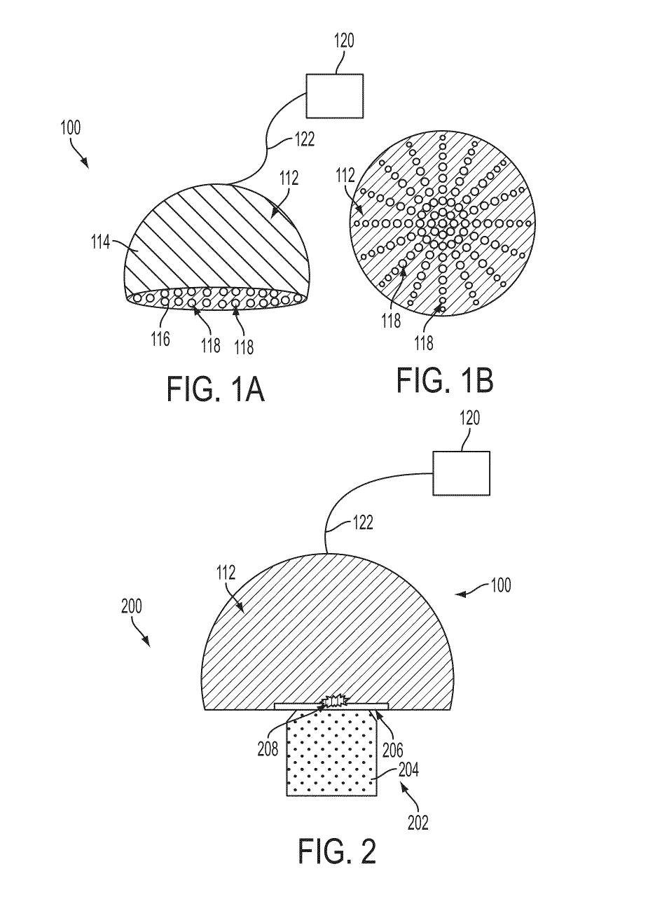

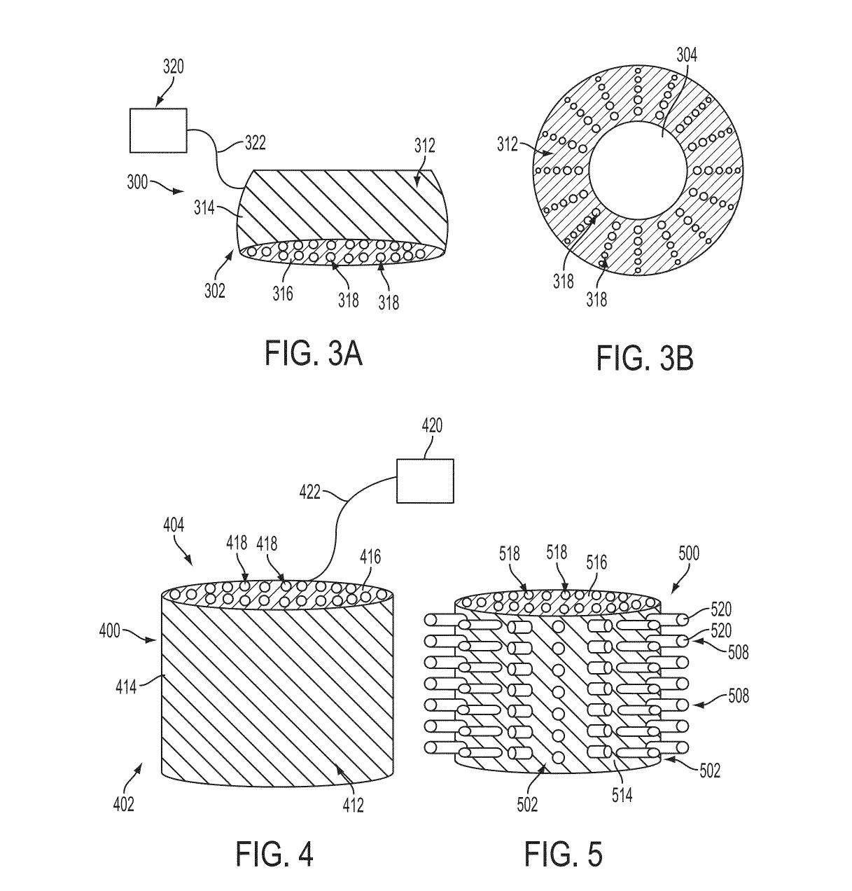

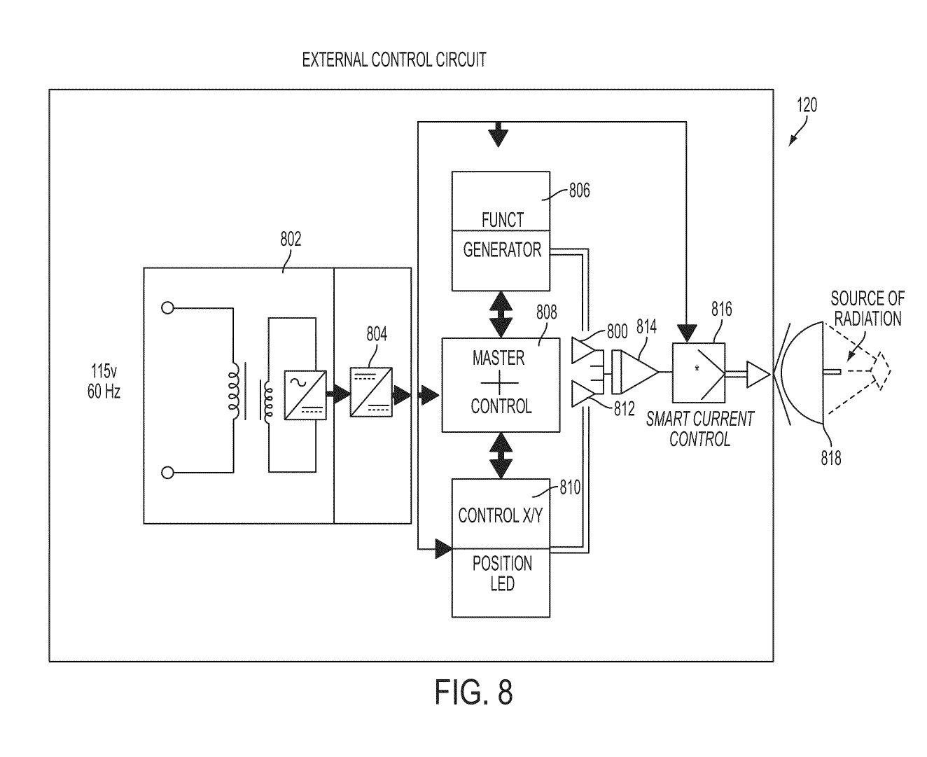

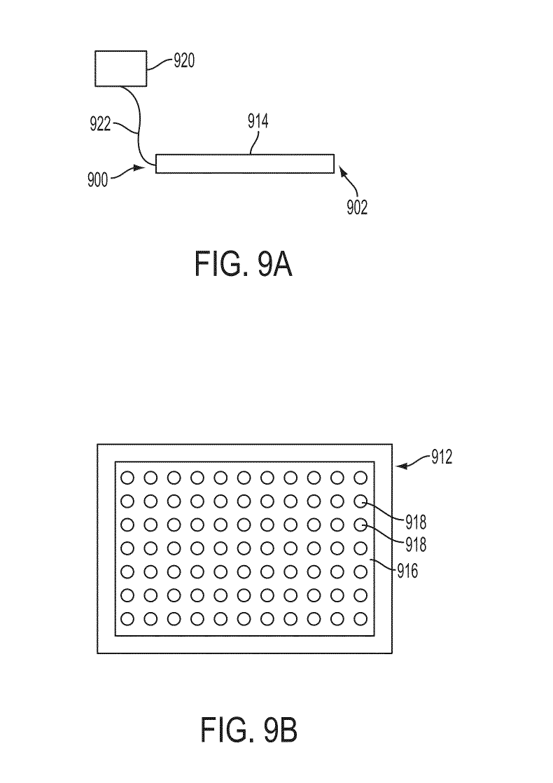

Referring to FIG. 1, a super resolution illumination (SRI) device 100 can include a body housing 112 in the shape of a hemisphere. The SRI body housing 112 can include an external surface 114 and an internal surface 116. The SRI body housing 112 further can include a plurality of sources of radiation 118 (e.g., light emitting diodes (LEDs)) that are uniformly or non-uniformly distributed on the internal surface 116. The LEDs 118 are electrically connected through a cable 122 to an external circuit 120 that powers and controls the LEDs 118 As illustrated in FIG. 8, external circuit 120 can include a power supply 802 with a DC to DC converter 804, which provides the necessary energy to the rest of the electronics including the master controller 808. The external circuit 120 further can include a function generator 806 coupled to the master controller 808 and an input buffer 811. The external circuit 120 further can include an X/Y position LED control 810 coupled to the master controller 808 and an input buffer 812. The output of the input buffers 811, 812 can be input to a selector/decoder 814 that distributes the power to the input of smart current control 816. The smart current control 816 powers and controls the plurality of radiation sources 818 (e.g., LEDs 118). The smart current control 816 regulates the output power of one or more of the plurality of radiation sources 818 such that the sources of radiation 818 can be simultaneously powered, equally powered or not equally powered. For example, at least one of the individual sources of radiation 818 is powered at a different power level from the power level of other individual sources of radiation 818. Although FIG. 1 illustrates that the body housing 112 is in the shape of a hemisphere, the SRI device 100 is not limited to just the shape of a hemisphere. It is contemplated that body housing 112 can take the shape of a partial hemisphere with a top portion removed (as shown in FIG. 3), the shape of a cylinder (as shown in FIG. 4), the shape of a flat screen (as shown in FIG. 9) and/or other geometric shapes.

In general, in an embodiment of this invention, a two-dimensional (2D) array of individual sources of radiation 118 are distributed on the internal surface 116 of a body housing 112, which has an arbitrary shape. As shown in FIGS. 1, 3-4 and 9 in an embodiment of this invention the individual sources of radiation 118, 318, 418, 918 are LEDs. Moreover, the individual sources of radiation can be selected from the group consisting of omnidirectional LEDs, highly directional LEDs and ultra-bright LEDs. In an alternative embodiment of this invention as illustrated in FIG. 5, the individual sources of radiation are optical fibers 508, which have a first end 518 that connects to the internal surface 516 of the body housing 512. A second end 520 of the optical fibers 508 is coupled to a large illumination source (not shown). In yet another aspect of the embodiment, the body housing has a shape different than a hemisphere such as a cylinder, a paraboloid, an ellipsoid or a flat screen.

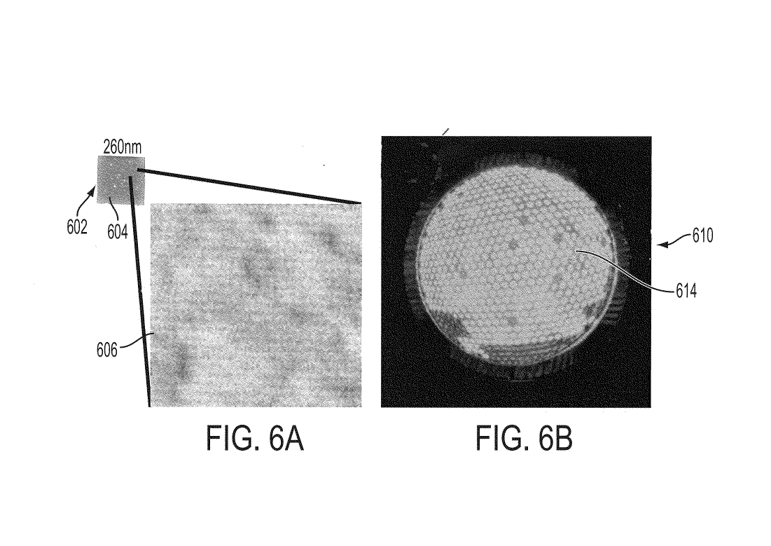

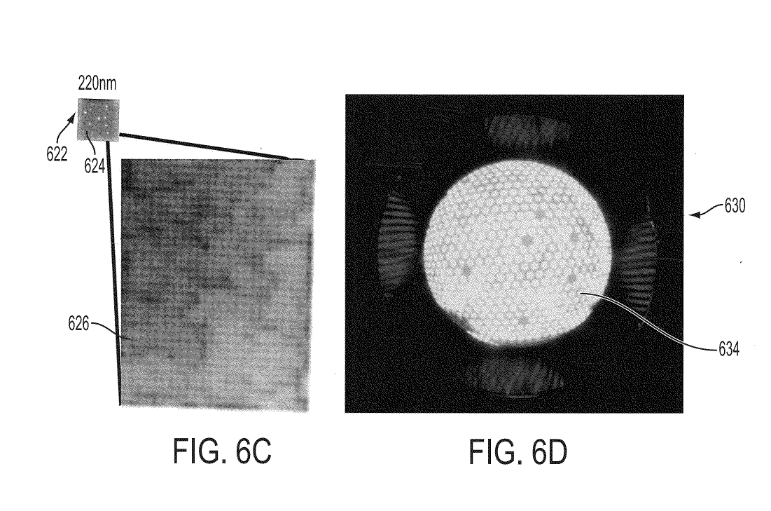

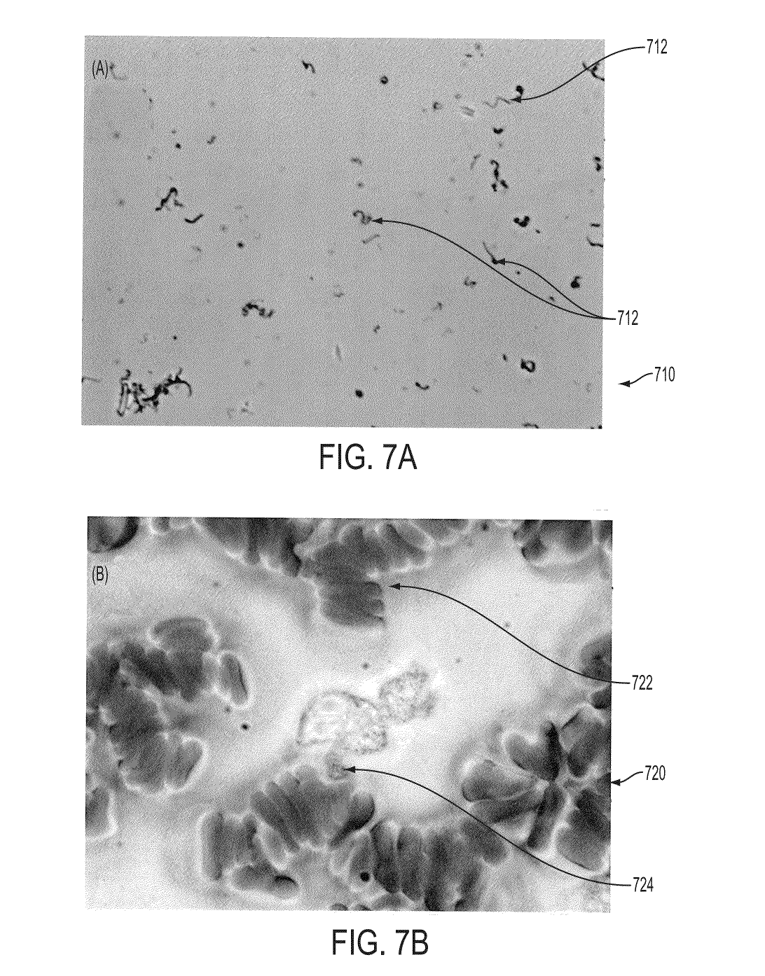

Referring to FIG. 2, a block diagram illustrating the various components of a SRI microscope system 200, in accordance with one embodiment of the present invention is provided. The SRI device 100 can include a body housing 112 in the shape of a hemisphere. The SRI body housing 112 can include an external surface 114 and an internal surface 116. The SRI body housing 112 further can include a plurality of light emitting diodes (LEDs) 118 that are distributed on the internal surface 116. The LEDs 118 are electrically connected through a cable 122 to an external circuit 120 that powers and controls the operation of the LEDs 118. The SRI device 100 is positioned on top of a traditional glass slide 206 used in conventional microscopes 202. In this way, the SRI device 100 substitutes for the traditional illumination source of conventional microscopes 202 and provides a collimate beam impinging perpendicularly on the glass slide 206 that contains the object under observation 208. The object under observation 208 is then illuminated by the light emitted in all directions by the plurality of LEDs 118 of the SRI device 100, which includes radiated light that have very large incidence angles. The illumination by the light that has very large incidence angles, which is emitted in all directions results in the demonstrated sub-wavelength resolution of the SRI-microscope system 200. Similar to conventional microscopy, imaging occurs in the SRI-microscope system 200 after collection by the microscope objective lens 204 of the light directly diffracted by the object under observation 208. FIGS. 6 and 7 demonstrate the sub-wavelength resolution capabilities of the SRI-microscope system 2. It is known that the observation of extended diffraction features instead of spots in the Fourier plane image results in sub-wavelength resolution (see for instance the following publications: C. J. Reagan, R. Rodriguez, S. Gourshetty, L. Grave de Peralta, and A. A. Bernussi, Imaging nanoscale features with plasmon-coupled leakage radiation far-field superlenses, Optics Express, vol. 20, page 20827, 2012; L. Grave de Peralta, C. J. Reagan, and A. A. Bernussi, SPP Tomography: a simple wide-field nanoscope, Scanning, vol. 35, page 246, 2013; R. Lopez-Boada, C. J. Reagan, D. Dominguez, A. A. Bernussi, and L. Grave de Peralta, Fundaments of optical far-field subwavelength resolution based on illumination with surface waves, Optics Express, vol. 21, page 11928, 2013). The collection of numerous bright spots 614, 634 observed in the Fourier plane images 610 and 630 shown in FIGS. 6B and 6D constitute an extended diffraction feature obtained with a SRI-microscope system 200. This illustrates a good correlation with the sub-wavelength resolution images 602 and 622 shown in FIGS. 6A and 6C. Real, wide-field images of the object under observation 208 with nano-resolution are formed analogically, without need of sample tagging, intensive computation and/or scanning by the microscope's lenses 204.

Other relevant variations are allowed in this invention with respect to the arrangement used in the experimental demonstration of a preferred embodiment of this invention described above. In other embodiments, the wavelength of the radiation emitted by the individual sources 118 can also be in the ultraviolet and/or infrared spectral range. A preferred embodiment of this invention uses an infrared SRI device 100 having LEDs 118 that emit infrared radiation with a wavelength in the range of λ˜1.2-1.5 μm. Silicon (Si) is transparent at these wavelengths; therefore, a common optical microscope 202 in combination with such an infrared SRI device 100 can be transformed in a super resolution infrared microscope 200 capable to image nanostructures fabricated on top of a Si wafer. Such a super resolution infrared microscope 200 will have numerous applications in the semiconductor industry.

Another preferred embodiment of this invention uses a more sophisticated electronic circuit 120 to power and control the 2D array of individual sources of radiation 118 distributed on the internal surface 116 of a body housing 112. Separate control of individual LEDs 118 may allow both spatial filtering and time multiplexing techniques that result in additional imaging capabilities for an embodiment of this invention.

Testing has established that the minimum observable period p using this invention is given by the following Equation (1):

$$p > \frac{λ}{na + N} \qquad ( 1 )$$

where n is the refractive index of the medium on top of the glass slide 206. In the visible frequency range, for example, evaluating Eq. (1) for n˜NA˜1.5 gives a minimum observable period of p˜λ/3, which corresponds to p˜190 nm for λ=568 nm. Moreover, in the infrared frequency range, evaluating Eq. (1) for n˜NA˜3.5 gives a minimum observable period of p˜λ/7, which corresponds to p˜215 nm for λ=1.5 μm. This result is in contrast to the minimum period observable with a traditional microscope, which is diffraction-limited to p˜λ/NA˜λ/1.5, or periods of ˜380 nm and 1000 nm, for wavelengths of 568 nm and 1.5 μm, respectively. This represents more than a 100% increase in the resolution of a conventional optical microscope by substituting a SRI device 100 for the original source of illumination. The periodic structures observed in the images illustrated in FIG. 6 are a demonstration of the super resolution capabilities of this invention as the period of the observed photonic crystals is p˜260-220 nm, which is below the minimum observable period of ˜380 nm when using a conventional microscope. The minimum observable period corresponds to a microscope angular bandwidth of Δk=2kₘₐₓ, where kₘₐₓ=2π/p; therefore, using ΔxΔk≈2π, the expected Rayleigh resolution limit of this invention is given by the following Equation (2):

$$Δ x > \frac{λ}{2 ( NA + n )} \qquad ( 2 )$$

As such, the Rayleigh resolution limit of this invention, Δx, is half of the value of the minimum observable period, p. For instance, evaluating Eq. (2) for n˜NA˜1.5 and n˜NA˜3.5 gives Δx˜k/6 and Δx˜λ/14, respectively, which corresponds to Δx˜95 nm and Δx˜107 nm, for λ=568 nm and λ=1.5 μm, respectively. This result is in contrast to the resolution limit of traditional microscopes, which are diffraction-limited to Δx˜λ/2NA, or ˜190 nm and ˜500 nm, for wavelengths of 568 nm and 1.5 μm, respectively. It should be noted that using a simple SRI source containing ultraviolet LEDs 118 would reduce the Rayleigh resolution limit of a common optical microscope to Δx˜50 nm, which is in the resolution range of a very sophisticated state of the art optical microscopy.

Referring to FIGS. 3A and 3B, a super resolution illumination (SRI) device 300 can include a body housing 312 in the shape of a partial hemisphere with a top portion removed, which defines an equatorial region 302 of a hemisphere. The SRI body housing 312 can include an external surface 314 and an internal surface 316. The SRI body housing 312 further can include a plurality of sources of radiation 318 (e.g., light emitting diodes (LEDs)) that are uniformly distributed on the internal surface 316. Similar to the SRI device 100 of FIG. 1, the LEDs 318 are electrically connected through a cable 322 to an external circuit 320 that powers and controls the LEDs 318. In the embodiment of FIGS. 3A and 3B, an aperture or opening 304 in the top of the hemisphere advantageously allows a user of the SRI-microscope system 200 to visually observe the object under observation 208 while the SRI device 300 is in use.

Referring to FIG. 4, a super resolution illumination (SRI) device 400 can include a body housing 412 in the shape of a cylinder 402. The SRI body housing 412 can include an external surface 414 and an internal surface 416. The SRI body housing 412 further can include a plurality of sources of radiation 418 (e.g., light emitting diodes (LEDs)) that are distributed on the internal surface 416. Similar to the SRI device 100 of FIG. 1, the LEDs 418 are electrically connected through a cable 422 to an external circuit 420 that powers and controls the LEDs 418. In the embodiment of FIG. 4, an aperture or opening 404 in the top of the cylinder advantageously allows a user of the SRI-microscope system 200 to visually observe the object under observation 208 while the SRI device 400 is in use.

Referring to FIG. 5, a super resolution illumination (SRI) device 500 can include a body housing 512 in the shape of a cylinder 502. Numerous optical fibers 508 can be uniformly distributed from the external surface 514 of body housing 512 to the internal surface 516 of body housing 512 that has a cylinder shape 502. A first end 518 of each fiber 508 connects to the internal surface 516 of the cylinder shape 502, which a second end 520 of each fiber is coupled to a large illumination source (not shown).

Referring to FIGS. 9A and 9B, a super resolution illumination (SRI) device 900 can include a body housing 912 in the shape of a flat screen 902. The SRI body housing 912 can include an external surface 914 and an internal surface 916. The SRI body housing 912 further can include a plurality of sources of radiation 918 (e.g., light emitting diodes (LEDs)) that are distributed on the internal surface 916. Similar to the SRI device 100 of FIG. 1, the LEDs 918 are electrically connected through a cable 922 to an external circuit 920 that powers and controls the LEDs 918. In one embodiment, a total of 36 LEDs were used to obtain enhanced resolution of the conventional microscope. In another embodiment, a total of 120 LEDs were used to obtain enhanced resolution of the conventional microscope. In yet another embodiment, a total of 1000 LEDs were used to obtain enhanced resolution of the conventional microscope.

FIGS. 6A and 6B illustrate optical images with sub-wavelength resolution obtained during an experimental demonstration of an embodiment of this invention. FIG. 6A is a real plane image 602, and FIG. 6B is a Fourier plane image 610, which correspond to photonic crystals with a period of 260 nm, which were obtained with a SRI-microscope system 200. FIG. 6C is a real plane image 622, and FIG. 6D is a Fourier plane image 630, which correspond to photonic crystals with a period of 220 nm, which were obtained with a SRI-microscope system 200. The square symmetry of the photonic crystal structure 606, 626 is clearly illustrated in the real plane images 602 and 622. The spots 604, 624 are image artifacts that disappear when the image 602, 622 are magnified. These structures are invisible for a traditional optical microscope; however, they are clearly visible using a preferred embodiment of this invention. This demonstrates the subwavelength resolution capabilities of this invention. Each bright spot 614 and 634 observed in the Fourier plane images 610 and 630 corresponds to an individual source of radiation (e.g., a LED) in the SRI device 100 used in this experimental demonstration of a preferred embodiment of this invention, which has a uniform distribution of LEDs in the internal surface 116 of the body housing 112 that has the shape of a hemisphere.

FIGS. 7A and 7B show optical images with sub-wavelength resolution obtained during an experimental demonstration of a preferred embodiment of this invention. The images were obtained with a SRI-microscope system 200 and correspond to a sample 710 with carbon nanotubes 712, which have diameters of 40-60 nm and a sample of human blood 720 placed on top of a glass slide 206. Single carbon nanotubes 712 are clearly observed in FIG. 7A. Piled disk-shaped red cells 722 and an ameba-shaped white cell 724 at the center of the image are observed in FIG. 7B. In addition, a rich sub-cellular internal structure of the white cell 724 is clearly observed.

In operation, the visible-light SRI device 100 used to obtain the images illustrated in FIGS. 6 and 7 includes 560 LEDs 112 distributed in the internal surface 116 of a body housing 112 in the shape of a hemisphere with a diameter of 10 cm. The LEDs 118 where electrically connected in series and simultaneously and equally powered through a common cable 122. A simple electronic circuit 120 was implemented to allow for control of the intensity illumination of the SRI device 100. A more elaborated electronic circuit 120 may allow for control of individual LEDs by increasing the imaging capabilities of the preferred embodiment of this invention. In the experimental demonstration of this invention, the conventional illumination of a Nikon inverse optical microscope 202 is substituted for the visible-light SRI device 100. This change with respect to the conventional optical microscopy 202 resulted in the observed super resolution. As shown in FIG. 2, the visible-light SRI device 100 was just on top of the glass slide 206 with the object under observation 208. The immersion oil microscope objective lens 204, with a numerical aperture of NA=1.49 and magnification λ100, was in optical contact with the bottom surface of the glass slide 206. The object under observation 208 was then illuminated by the light emitted in all directions by the LEDs 118, which included light with very large incidence angles. This procedure resulted in the demonstrated sub-wavelength resolution of the SRI-microscope system 200. Similar to traditional microscopy, imaging occurs in the SRI-microscope system 200 after collection by the microscope objective lens 204 of the light directly diffracted by the object under observation 208. Real, wide-field images of the object under observation 208 with sub-wavelength resolution were formed analogically, without the need of sample tagging, intensive computation or scanning, by the microscope's lenses.

Some variations are allowed in this invention with respect to the arrangement used in the experimental demonstration of a preferred embodiment of this invention described above. As illustrated in FIGS. 3-4, the shape of the body housing 312 where the LEDs 318 are distributed can be different from a hemisphere 312. FIG. 3 illustrates an alternative embodiment of this invention where the LEDs 318 are uniformly distributed in the internal surface 316 of the equatorial region 302 of a hemisphere shape. FIG. 4 illustrates another instance of this invention where the LEDs 418 are uniformly distributed in the internal surface 416 of a solid cylinder 402. In both variations of this invention the aperture 304 on the top of the body housing 312 permits a user of the SRI-microscope system 200 to visually observe of the object under observation 208 while the SRI apparatus 300, 400 is in use.

The invention has been described with respect to certain preferred embodiments, but the invention is not limited only to the particular constructions disclosed and shown in the drawings as examples, and also comprises the subject matter and such reasonable modifications or equivalents as are encompassed within the scope of the appended claims.

What is claimed is:

1. A portable microscope super-resolution illumination (SRI) apparatus for use with a conventional optical microscope, the apparatus comprising:
a two dimensional (2D) array of individual sources of radiation distributed in the internal surface of a body housing; and
a power supply with an electronic circuit designed to power and control the array of individual sources of radiation.

2. The microscope SRI apparatus of claim 1, wherein the individual sources of radiation emit radiation in the visible frequency range of the spectrum.

3. The microscope SRI apparatus of claim 1, wherein the individual sources emit radiation in the ultraviolet frequency range of the spectrum.

4. The microscope SRI apparatus of claim 1, wherein the individual sources emit radiation in the infrared frequency range of the spectrum.

5. The microscope SRI apparatus of claim 1, wherein at least one of the individual sources emits radiation in a frequency range of the spectrum that is different from the frequency range emitted by other individual sources.

6. The microscope SRI apparatus of claim 1, wherein the body housing is a hemisphere.

7. The microscope SRI apparatus of claim 1, wherein the body housing is a portion of a hemisphere.

8. The microscope SRI apparatus of claim 1, wherein the body housing has a shape selected from the group consisting of a cylinder, a paraboloid, an ellipsoid and a flat screen.

9. The microscope SRI apparatus of claim 1, wherein the individual sources of radiation are powered simultaneously at the same level.

10. The microscope SRI apparatus of claim 1, wherein the individual sources of radiation are not powered simultaneously at the same power level and at least one of the individual sources is powered at a different power level from the power level of the other individual sources.

11. The microscope SRI apparatus of claim 1, wherein the individual sources of radiation are light emitting diodes (LEDs).

12. The microscope SRI apparatus of claim 1, wherein the individual sources of radiation are optical fibers coupled to a source of illumination.

13. The microscope SRI apparatus of claim 1, wherein the individual sources of radiation are selected from the group consisting of omnidirectional LEDs, highly directional LEDs and ultra-bright LEDs.

14. A super-resolution illumination (SRI) microscope system, the system comprising:
a conventional optical microscope; and
a portable microscope super-resolution illumination (SRI) apparatus adapted for use with the conventional optical microscope to provide direct observation of objects smaller than a wavelength of radiation used for illumination, wherein the microscope SRI apparatus comprises:
a two dimensional (2D) array of individual sources of radiation distributed in the internal surface of a body housing; and
a power supply with an electronic circuit designed to power and control the array of individual sources of radiation.

15. The super-resolution illumination (SRI) microscope system of claim 14, wherein the individual sources of radiation emit radiation in the visible frequency range of the spectrum.

16. The super-resolution illumination (SRI) microscope system of claim 14, wherein the individual sources emit radiation in the ultraviolet frequency range of the spectrum.

17. The super-resolution illumination (SRI) microscope system of claim 14, wherein the individual sources emit radiation in the infrared frequency range of the spectrum.

18. The super-resolution illumination (SRI) microscope system of claim 14, wherein at least one of the individual sources emits radiation in a frequency range of the spectrum that is different from the frequency range emitted by other individual sources.

19. The super-resolution illumination (SRI) microscope system of claim 14, wherein the body housing is a hemisphere.

20. The super-resolution illumination (SRI) microscope system of claim 14, wherein the body housing is a portion of a hemisphere.
